(19) United States
(12) Patent Application Publication
(10) Pub. No.: US 2023/0362716 A1
(43) Pub. Date: Nov. 9, 2023

(54) METHOD AND APPARATUS FOR DETERMINING MACHINE LEARNING MODEL BASED ON NETWORK CONGESTION INFORMATION IN WIRELESS COMMUNICATION SYSTEM

(71) Applicant: Samsung Electronics Co., Ltd., Suwon-si (KR)

(72) Inventors: Jungshin PARK, Suwon-si (KR); Mehrdad SHARIAT, Staines (GB)

(21) Appl. No.: 18/309,297

(22) Filed: Apr. 28, 2023

(30) Foreign Application Priority Data
May 3, 2022 (KR) 10-2022-0055000

(51) Int. Cl. H04W 28/02; H04L 41/16; H04W 60/00

(52) U.S. Cl. CPC H04W 28/0284; H04L 41/16; H04W 60/00

(57) ABSTRACT

A method performed by an access and mobility management function (AMF) node in a wireless communication system is provided. The method includes receiving a first control message including information on a registration request from a terminal, transmitting, to the terminal, a registration response message including information on whether network analysis of the terminal is acceptable, transmitting a message requesting information on the network analysis based on the first control message to a network data collection and analysis function (NWDAF) node, receiving information on the network analysis from the NWDAF node, identifying information about network congestion of the terminal based on the information on the network analysis, and transmitting a second control message including information about the network congestion to the terminal.

### CROSS-REFERENCE TO RELATED APPLICATION(S)

This application is based on and claims priority under 35 U.S.C. § 119(a) of a Korean patent application number 10-2022-0055000, filed on May 3, 2022, in the Korean Intellectual Property Office, the disclosure of which is incorporated by reference herein in its entirety.

### BACKGROUND

### 1. Field

The disclosure relates to a method and an apparatus for determining a machine learning model and an algorithm in a wireless communication system. More particularly, the disclosure relates to a method and an apparatus in which a machine learning application of a terminal receives network congestion information from a network and determines a machine learning model to be applied to the application based on the received information in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The Internet, which is a human centered connectivity network where humans generate and consume information, is now evolving to the Internet of things (IoT) where distributed entities, such as things, exchange and process information without human intervention. The Internet of everything (IoE) may be an example of a combination of the IoT technology and the big data processing technology through connection with a cloud server.

As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology.

With the development of the mobile communication system as described above, a terminal may easily use computing capability provided by a server of a network through a mobile communication system as needed, and accordingly the use of AI applications applying machine learning (ML) algorithms that require complex calculations having been considered impossible in a terminal is increasingly being considered. These AI applications uses a method for utilizing resources of a network server through a wireless communication system, the application performance experienced by a user is greatly affected by a communication state of the wireless communication system, and accordingly, a method capable of controlling ML models and algorithms according to the state of the wireless communication system is required.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of providing improved efficiency of applications in a wireless communication system.

Another aspect of the disclosure is to provide a method and an apparatus in which a terminal requests and receives network state information and determines a machine learning model and algorithm to be applied to an application based on the information in a wireless communication system.

Another aspect of the disclosure is to provide a method and an apparatus in which a network entity for providing data analysis and collection functions provides network state information requested by a user equipment (UE) in a wireless communication system.

Another aspect of the disclosure is to provide a method and an apparatus for controlling signal flow between network function (NF) entities to transfer data required for analyzing a network congestion state.

Another aspect of the disclosure is to provide a method and an apparatus for controlling signal flow between a terminal and network functional entities to transfer network state information to the terminal.

Additional aspects will be set forth in part in the description which follows and, in part, will be apparent from the description, or may be learned by practice of the presented embodiments.

In accordance with an aspect of the disclosure, a method performed by an access and mobility management function (AMF) node in a wireless communication system is provided. The method includes receiving a first control message including information on a registration request from a terminal, transmitting, to the terminal, a registration response message including information on whether network analysis of the terminal is acceptable, transmitting a message requesting information on the network analysis based on the first control message to a network data collection and analysis function (NWDAF) node, receiving information on the network analysis from the NWDAF node, identifying information about network congestion of the terminal based on the information on the network analysis, and transmitting a second control message including information about the network congestion to the terminal.

In accordance with another aspect of the disclosure, a method performed by a terminal in a wireless communication system is provided. The method includes transmitting a first control message including information on a registration request to an access and mobility management function (AMF) node, receiving, from the AMF node, a registration response message including information on whether network analysis of the terminal is acceptable, receiving, from the AMF node, a second control message including information about network congestion, which is identified based on information about network analysis transmitted from a network data collection and analysis function (NWDAF) node, and identifying an artificial intelligence (AI)/machine learning (ML) model used by the terminal based on the information about the network congestion.

Various embodiments of the disclosure may provide an apparatus and a method capable of effectively providing a service in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a communication network including core network entities in a wireless communication system according to an embodiment of the disclosure;

FIG. 2A illustrates a wireless environment including a core network in a wireless communication system according to an embodiment of the disclosure;

FIG. 2B illustrates a configuration of a core network object in a wireless communication system according to an embodiment of the disclosure;

FIG. 2C illustrates a configuration of a UE in a wireless communication system according to an embodiment of the disclosure;

FIG. 3 illustrates a communication network including network data collection and analysis functionality according to an embodiment of the disclosure;

FIG. 4 illustrates a general structure of a wireless communication system in which a UE receives and applies network congestion information according to an embodiment of the disclosure;

FIG. 5 is a signal flow illustrating collecting and analyzing network data by a UE according to an embodiment of the disclosure;

FIG. 6 is a signal flow illustrating changing a model and an algorithm to be applied based on network congestion information received by a UE according to an embodiment of the disclosure;

FIG. 7 is a flowchart illustrating an operation of an AMF for determining a machine learning model based on network congestion information according to an embodiment of the disclosure; and

FIG. 8 is a flowchart illustrating an operation of a UE for determining a machine learning model based on network congestion information according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing embodiments of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Further, the “unit” in the embodiments may include one or more processors.

In the following description, some of terms and names defined in the 3rd generation partnership project long term evolution (3GPP LTE)-based communication standards (e.g., standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

Hereinafter, the disclosure relates to an apparatus and method for determining a machine learning (ML) model in a wireless communication system. Specifically, the disclosure describes a technique in which a machine learning application of a terminal receives network congestion information from a network and determines a machine learning model to be applied to the application based on the received information in a wireless communication system.

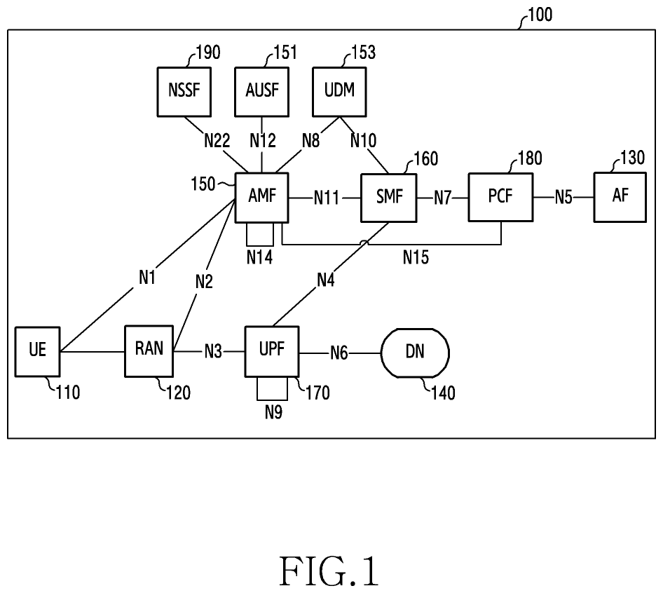

FIG. 1 illustrates a communication network 100 including core network entities in a wireless communication system according to an embodiment of the disclosure. A 5G mobile communication network may include a 5G user equipment (UE) 110, a 5G radio access network (RAN) 120, and a 5G core network.

The 5G core network may include network functions such as, an access and mobility management function (AMF) 150 for providing a mobility management function of the UE, a session management function (SMF) 160 for providing a session management function, a user plane function (UPF) 170 for performing data transfer, a policy control function (PCF) 180 for providing a policy control function, a unified data management (UDM) 153 for providing a function of managing data such as subscriber data and policy control data, or a unified data repository (UDR) for storing data of various network functions.

Referring to FIG. 1, a user equipment (UE) 110 may perform communication through a radio channel established with a base station (e.g., eNodeB (eNB) or next generation node B (gNB)), that is, an access network. In some embodiments, the UE 110 is a device used by a user and may be a device configured to provide a user interface (UI). As an example, the UE 110 may be equipment mounted on a vehicle for driving. In some other embodiments, the UE 110 may be a device that performs machine type communication (MTC) operated without user involvement, or may be an autonomous vehicle. The UE may be referred to, in addition to an electronic device, as terms such as a ‘terminal’, ‘vehicle terminal’, ‘user equipment (UE)’, ‘mobile station’, ‘subscriber station’, ‘remote terminal’, ‘wireless terminal’, ‘user device’, or other terms having equivalent technical meaning. A customer-premises equipment (CPE) or dongle type terminal may be used, as the terminal, in addition to the UE. The customer premises device may provide a network to other communication equipment (e.g., laptop) while being connected to a next generation radio access network (NG-RAN) node like the UE.

Referring to FIG. 1, the AMF 150 provides a function for access and mobility management in units of UE 110, and each UE 110 may be basically connected to one AMF 150. Specifically, the AMF 150 may perform at least one function among signaling between core network nodes for mobility between 3GPP access networks, an interface (N2 interface) between radio access networks (e.g., 5G RAN) 120, NAS signaling with the UE 110, identification of the SMF 160, and transmission and providing of a session management (SM) message between the UE 110 and the SMF 160. Some or all of the functions of the AMF 150 may be supported within a single instance of one AMF 150.

Referring to FIG. 1, the SMF 160 provides a session management function, and when the UE 110 has multiple sessions, each session may be managed by a different SMF 160. Specifically, the SMF 160 may perform at least one function among session management (e.g., establishment, modification, and release of a session including maintenance of a tunnel between the UPF 170 and an access network node), selection and control of a user plane (UP) function, configuration of traffic steering for routing traffic to an appropriate destination from the UPF 170, termination of an SM part of a NAS message, downlink data notification (DDN), and an initiator of AN-specific SM information (e.g., transmission to an access network through an N2 interface via the AMF 150). Some or all functions of the SMF 160 may be supported within a single instance of one SMF 160.

In the 3GPP system, conceptual links connecting between network functions (NFs) in the 5G system may be referred to as a reference point. The reference point may also be referred to as an interface. Reference points included in the 5G system architecture represented through FIGS. 1, 2A to 2C, and 3 to 7 are described as follows.
N1: reference point between UE 110 and AMF 150
N2: reference point between (R)AN 120 and AMF 150
N3: Reference point between (R)AN 120 and UPF 170
N4: Reference point between SMF 160 and UPF 170
N5: Reference point between PCF 180 and application function (AF) 130
N6: Reference point between UPF 170 and data network (DN) 140
N7: reference point between SMF 160 and PCF 180
N8: reference point between UDM 153 and AMF 150
N9: Reference point between two core UPFs 170
N10: Reference point between UDM 153 and SMF 160
N11: Reference point between AMF 150 and SMF 160
N12: Reference point between AMF 150 and authentication server function (AUSF) 151
N13: Reference point between UDM 153 and authentication server function 151
N14: reference point between two AMFs 150
N15: reference point between PCF 180 and AMF 150 in the case of non-roaming scenario and reference point between PCF 180 within visited network and AMF 150 in the case of roaming scenario

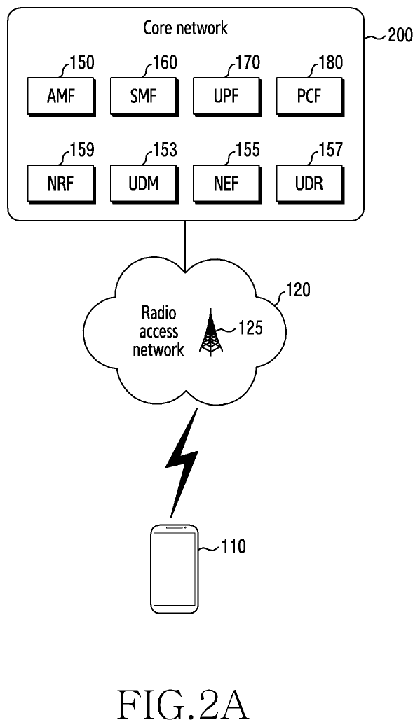

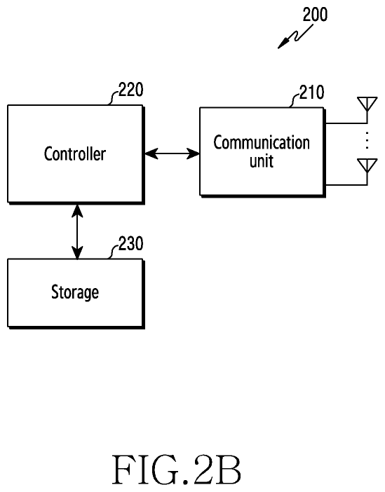

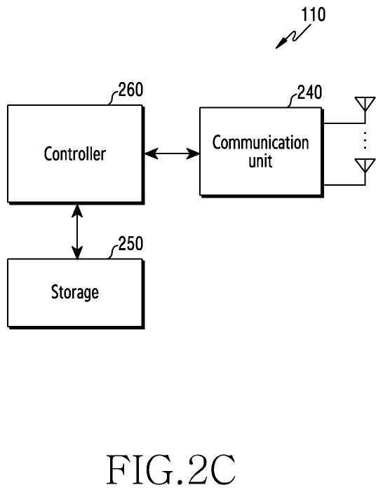

FIG. 2A illustrates a wireless environment including a core network 200 in a wireless communication system according to an embodiment of the disclosure.

Referring to FIG. 2A, the wireless communication system includes a radio access network (RAN) 120 and a core network (CN) 200.

The radio access network 120 is a network directly connected to a user device, for example, the UE 110, and is an infrastructure that provides radio access to the UE 110. The radio access network 120 includes a set of a plurality of base stations including a base station 125, and the plurality of base stations may perform communication through an interface established between the base stations. At least some of the interfaces between the plurality of base stations may be formed in a wired or wireless manner. The base station 125 may have a structure in which a central unit (CU) and a distributed unit (DU) are separated. In this case, one CU may control a plurality of DUs. The base station 125 may be referred to as, in addition to a base station, an ‘access point (AP)’, a ‘next generation node B (gNB)’, a ‘5th generation node (5G node)’, a ‘wireless point’, ‘transmission/reception point (TRP)’, or other terms having an equivalent technical meaning. The UE 110 accesses the radio access network 120 and communicates with the base station 125 through a radio channel. The UE 110 may be referred to as, in addition to a terminal, terms including a ‘user equipment (UE)’, a ‘mobile station’, a ‘subscriber station’, a ‘remote terminal’, a ‘wireless terminal’, a ‘user device’, or other terms having an equivalent technical meaning.

The core network 200 is a network that manages the entire system, which controls the radio access network 120 and processes data and control signals for the UE 110, which are transmitted and received through the radio access network 120. The core network 200 performs various functions, such as controlling a user plane and a control plane, processing mobility, managing subscriber information, charging, and interworking with other types of systems (e.g., long-term evolution (LTE) system). In order to perform the various functions described above, the core network 200 may include a plurality of functionally separated entities having different network functions (NFs). For example, the core network 200 may include an access and mobility management function (AMF) 150, a session management function (SMF) 160, a user plane function (UPF) 170, a policy and charging function (PCF) 180, a network repository function (NRF) 159, a user data management (UDM) 153, a network exposure function (NEF) 155, and a unified data repository (UDR) 157.

The UE 110 is connected to the radio access network 120 and accesses the AMF 150 that performs a mobility management function of the core network 200. The AMF 150 is a function or device that is in charge of both access to the radio access network 120 and mobility management of the UE 110. The SMF 160 is an NF to manage a session. The AMF 150 is connected to the SMF 160, and routes a message relating to a session for the UE 110 to the SMF 160. The SMF 160 is connected to the UPF 170, allocates a user plane resource to be provided to the UE 110, and establishes a tunnel to transmit data between the base station 125 and the UPF 170. The PCF 180 controls information related to a policy and charging for a session used by the UE 110. The NRF 159 performs a function of storing information about NFs installed in a mobile communication service provider network and notifying of the stored information. The NRF 159 may be connected to all NFs. When starting operation in a service provider network, each NF provides, to the NRF 159, a notification that a corresponding NF is being operated in the network, by performing registration in the NRF 159. The UDM 153 is an NF to perform a function similar to that of a home subscriber server (HSS) of a fourth generation (4G) network, and stores subscription information of the UE 110 or context used by the UE 110 in the network.

The NEF 155 serves to connect a 3rd party server and an NF in the 5G mobile communication system. In addition, the NEF serves to provide data to the UDR 157, or update or acquire data. The UDR 157 performs a function to store subscription information of the UE 110, store policy information, store data exposed to the outside, or store information required for a 3rd party application. In addition, the UDR 157 also serves to provide stored data to another NF.

FIG. 2B illustrates a configuration of a core network object in a wireless communication system according to an embodiment of the disclosure. A configuration 200 illustrated in FIG. 2B may be understood as a configuration of a device having at least one of the functions 150, 153, 155, 157, 160, 170, 180, and 190 of FIG. 1. The terms ‘˜ unit’ or ‘˜ er’ used hereinafter may refer to a unit for processing at least one function or operation and may be implemented in hardware, software, or a combination of hardware and software.

Referring to FIG. 2B, a core network object includes a communication unit 210, a storage 230, and a controller 220.

The communication unit 210 provides an interface for communicating with other devices in a network. That is, the communication unit 210 converts a bit string, which is transmitted from the core network object to another device, into a physical signal, and converts a physical signal, which is received from the other device, into a bit string. That is, the communication unit 210 may transmit or receive signals. Accordingly, the communication unit 210 may be referred to as a modem, a transmitter, a receiver, or a transceiver. Here, the communication unit 210 enables the core network object to communicate with other devices or systems via a backhaul connection (e.g., wired backhaul or wireless backhaul) or via a network.

The storage 230 stores data, such as a basic program, an application program, and configuration information for the operation of the core network object. The storage 230 may include a volatile memory, a non-volatile memory, or a combination of volatile and non-volatile memories. In addition, the storage 230 provides stored data according to the request of the controller 220.

The controller 220 is configured to control overall operations of core network object. For example, the controller 220 is configured to transmit or receive signals through the communication unit 210. In addition, the controller 220 is configured to write and read data in and from the storage 230. To this end, the controller 220 may include at least one processor. According to various embodiments of the disclosure, the controller 220 may be configured to perform control to achieve synchronization using a wireless communication network. For example, the controller 220 may be configured to control a core network object to perform operations according to various embodiments described below.

FIG. 2C shows the configuration of a UE in a wireless communication system according to an embodiment of the disclosure. The configuration illustrated in FIG. 2C may be understood as the configuration of the UE 110. The terms ‘˜ unit’ or ‘˜ er’ used hereinafter may refer to a unit for processing at least one function or operation and may be implemented in hardware, software, or a combination of hardware and software.

Referring to FIG. 2C, the UE includes a communication unit 240, a storage 250, and a controller 260.

The communication unit 240 performs functions for transmitting or receiving a signal through a wireless channel. For example, the communication unit 240 performs a function of conversion between a baseband signal and a bit stream according to a physical layer standard of a system. For example, when data is transmitted, the communication unit 240 generates complex symbols by encoding and modulating a transmission bit stream. Further, when data is received, the communication unit 240 restores a reception bit stream by demodulating and decoding a baseband signal. In addition, the communication unit 240 up-converts a baseband signal into an RF band signal and transmits the same through an antenna, and down-converts an RF band signal received through an antenna into a baseband signal. For example, the communication unit 240 may include a transmission filter, a reception filter, an amplifier, a mixer, an oscillator, a digital-to-analog converter (DAC), an analog-to-digital converter (ADC), and the like.

In addition, the communication unit 240 may include a plurality of transmission/reception paths. Further, the communication unit 240 may include at least one antenna array including multiple antenna elements. In terms of hardware, the communication unit 240 may include a digital circuit and an analog circuit (e.g., a radio frequency integrated circuit (RFIC)). The digital circuit and the analog circuit may be implemented in a single package. In addition, the communication unit 240 may include a plurality of RF chains. Furthermore, the communication unit 240 may perform beamforming.

The communication unit 240 transmits and receives a signal as described above. Accordingly, all or a part of the communication unit 240 may be referred to as a ‘transmitter’, a ‘receiver’, or a ‘transceiver’. In addition, transmission and reception performed through a wireless channel, which will be described in the following descriptions, may be understood to imply that the above-described processing is performed by the communication unit 240.

The storage 250 may store data, such as a basic program for operation of a UE, an application program, configuration information, and the like. The storage 250 may include a volatile memory, a non-volatile memory, or a combination of a volatile memory and a non-volatile memory. The storage 250 provides stored data in response to a request of the controller 260.

The controller 260 is configured to control overall operations of the UE. For example, the controller 260 is configured to transmit and receive a signal via the communication unit 240. Further, the controller 260 is configured to record data in the storage 250 and read the recorded data. The controller 260 may be configured to perform functions of a protocol stack required by the communication standard. To this end, the controller 260 may include at least one processor or a micro-processor, or may be a part of a processor. A part of the communication unit 240 and the controller 260 may be referred to as a communication processor (CP). According to various embodiments, the controller 260 may be configured to perform control to achieve synchronization using a wireless communication network. For example, the controller 260 may be configured to control the UE to perform operations according to various embodiments described below.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

The following detailed description of embodiments of the disclosure is directed to New RAN (NR) as a radio access network and Packet Core as a core network (5G system, 5G Core Network, or new generation core (NG Core)) which are specified in the 5G mobile communication standards defined by the 3rd generation partnership project long term evolution (3GPP LTE) that is a mobile communication standardization group, but based on determinations by those skilled in the art, the main idea of the disclosure may be applied to other communication systems having similar backgrounds or channel types through some modifications without significantly departing from the scope of the disclosure.

In the 5G system, in order to support network automation, a network data collection and analysis function (NWDAF), which is a network function that provides a function of analyzing and providing data collected from the 5G network, may be defined. The NWDAF may collect/store/analyze information from the 5G network and provide a result of the same to at least one network function (NF), and the analysis result may be used independently in each NF.

The 5G mobile communication system may support NFs to use the result of collection and analysis of network-related data (hereinafter referred to as network data) through the NWDAF. This support is made to provide the collection and analysis of necessary network data in a centralized form in order for each NF to effectively provide its own functions. The NWDAF may collect and analyze network data using a network slice as a basic unit. However, the scope of the disclosure is not limited to a network slice unit, and NWDAF may additionally analyze a user equipment (UE), protocol data unit (PDU) session, NF state, and/or various pieces of information obtained from an external service server (e.g., service quality).

The results analyzed through NWDAF are delivered to each NF that has requested the analysis results, and the delivered analysis results may be used to optimize network management functions such as guarantee/improvement of quality of service (QoS), traffic control, mobility management, and load balancing.

A unit node that performs each function provided by the 5G network system may be defined as an NF (e.g., NF entity or NF node). Each NF may include at least one of an access and mobility management function (AMF) that manages access and mobility to an access network (AN) of a UE, a session management function (SMF) that performs management relating to a session, a user plane function (UPF) that manages a user data plane, and a network slice selection function (NSSF) 190 (FIG. 1) that selects a network slice instance available by the UE.

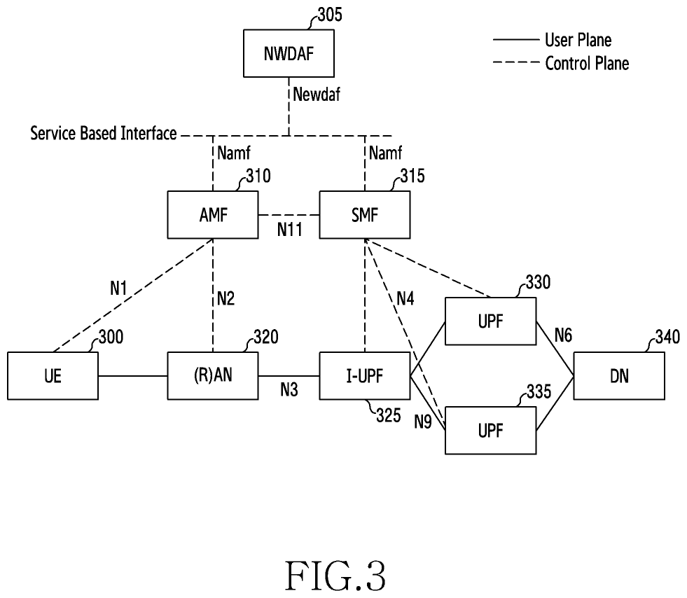

FIG. 3 illustrates a communications network including a network data collection and analysis function (NWDAF) according to an embodiment of the disclosure.

Referring to FIG. 3, a NWDAF 305 may collect network data in a various manner from at least one source NF (e.g., NFs in a 5G core network such as an AMF 310, an SMF 315, or a UPF 325, 330, 335, an application function (AF) for effective service providing, a network exposure function (NEF), or an operation, administration, and maintenance (OAM)). The AMF 310 may be connected to a UE 300 and a radio access network (RAN) 320. The UPF 325, 330, 335 may connect user traffic of the UE 300 through the RAN 320 to at least one data network (DN) 340.

The NWDAF 305 may provide analysis of network data collected from the network or outside to at least one consumer NF. The NWDAF 305 may collect and analyze the load level of a network slice instance and provide the same to an NSSF so as to be used for a specific UE to select. A service based interface defined in the 5G network may be used to request analysis information or transfer analysis information including an analysis result between the NFs 310 and 315, such as AMF and SMF, and the NWDAF 305. A hypertext transfer protocol (HTTP) and/or java script object notation (JSON) document may be used as a transfer method of analysis information.

According to an embodiment, the collected data of the NWDAF 305 may include at least one of an application identifier (ID), Internet protocol (IP) filter information, or media/application bandwidth from a point coordination function (PCF), UE identifier or location information from the AMF 310, destination data network name (DNN), UE IP, QoS flow bit rate, QoS Flow ID (QFI), QoS flow error rate, or QoS flow delay from the SMF, or traffic usage report from the UPF.

The NWDAF 305 may additionally collect, in addition to the NFs constituting the core network, at least one of NF resource status, NF throughput, or service level agreement (SLA) information provided from OAM, which is an entity that may affect the connection between the UE 300 and the service server, at least one of UE status, UE application information, or UE usage pattern provided from the UE 300, or at least one of an application identifier, service experience, or traffic pattern of a service provided from the AF, and may use the same for analysis.

Hereinafter, Tables 1 to 3 show examples of network data collected by the NWDAF. However, according to various embodiments of the disclosure, this is only an example, and network data collected by NWDAF is not limited to Tables 1 to 3. The period and time point at which the NWDAF 305 collects network data from each entity may be different for each entity. Based on a correlation ID for correlating data to be collected and a timestamp for recording a collection time, correlation of collected data may be distinguished.

TABLE 1

| Information | Source | Description |
|---|---|---|
| Application ID | AF | To identify the service and support analytics per |
| | | type of service (the desired level of service) |
| IP filter information | AF | Identify a service flow of the UE for the |
| | | application |
| Locations of Application | AF/NEF | Locations of application represented by a list of |
| | | DNAI(s). The NEF may map the AF-Service- |
| | | Identifier information to a list of DNAI(s) when |
| | | the DNAI(s) being used by the application are |
| | | statically defined. |
| Service Experience | AF | Refers to the QoE per service flow as established |
| | | in the SLA and during on boarding. It can be either |
| | | e.g. MOS or video MOS as specified in ITU-T |
| | | P.1203.3 or a customized MOS |
| Timestamp | AF | A time stamp associated to the Service Experience |
| | | provided by the AF, mandatory if the Service |
| | | Experience is provided by the ASP. |

TABLE 2

| Information | Source | Description |
|---|---|---|
| Timestamp | 5GC NF | A time stamp associated with the collected |
| | | information. |
| Location | AMF | The UE location information. |
| SUPI(s) | AMF | If UE IDs are not provided as target of analytics |
| | | reporting for slice service experience, AMF returns |
| | | the UE IDs matching the AMF event filters. |
| DNN | SMF | DNN for the PDU Session which contains the QoS |
| | | flow |
| S-NSSAI | SMF | S-NSSAI for the PDU Session which contains the |
| | | QoS flow |
| Application ID | SMF | Used by NWDAF to identify the application service |
| | | provider and application for the QoS flow |
| IP filter information | SMF | Provided by the SMF, which is used by NWDAF to |
| | | identify the service data flow for policy control |
| | | and/or differentiated charging for the QoS flow |
| QFI | SMF | QoS Flow Identifier |
| QoS flow Bit Rate | UPF | The observed bit rate for UL direction; and |
| | | The observed bit rate for DL direction |
| QoS flow Packet Delay | UPF | The observed Packet delay for UL direction; and |
| | | The observed Packet delay for the DL direction |
| Packet transmission | UPF | The observed number of packet transmission |
| Packet retransmission | UPF | The observed number of packet retransmission |

TABLE 3

| Information | Source | Description |
|---|---|---|
| Timestamp | OAM | A time stamp associated with the collected information. |
| Reference Signal | OAM | The per UE measurement of the received power |
| Received Power | | level in a network cell, including SS-RSRP, CSI- |
| | | RSRP as specified in clause 5.5 of TS 38.331 and |
| | | E-UTRA RSRP as specified in clause 5.5.5 of TS |
| | | 36.331 |
| Reference Signal | OAM | The per UE measurement of the received quality in |
| Received Quality | | a network cell, including SS-RSRQ, CSI-RSRQ as |
| | | specified in clause 5.5 of TS 38.331 and E-UTRA |
| | | RSRQ as specified in clause 5.5.5 of TS 36.331 |
| Signal-to-noise and | OAM | The per UE measurement of the received signal to |
| interference ratio | | noise and interference ratio in a network cell, |
| | | including SS-SINR, CSI-SINR, E-UTRA RS- |
| | | SINR, as specified in clause 5.1 of TS 38.215 |

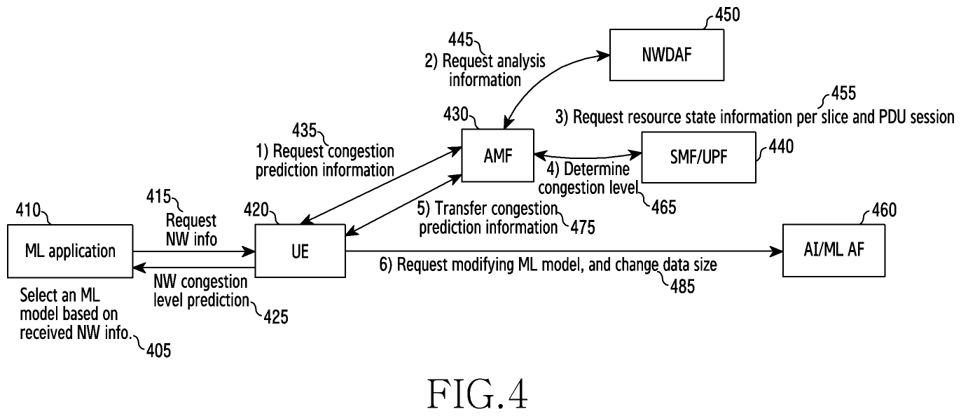

FIG. 4 illustrates a general structure of a wireless communication system in which a UE receives and applies network congestion information according to an embodiment of the disclosure. Specifically, FIG. 4 illustrates a general structure of a wireless communication system in which an artificial intelligence (AI)/machine learning (ML) application 410 of a UE receives network congestion information provided by a communication service provider and applies the received information to an ML model.

Referring to FIG. 4, the AI/ML application 410 of the UE may request network state information from a wireless communication network in order to determine an ML model and algorithm to be used for learning or inference. The ML model used by the application 410 may be configured by models that require different accuracy (e.g., inference performance) and computing levels to enable selection according to a network state. According to an embodiment, different models may be configured by increasing or decreasing the number of layers of the deep learning model or changing the depth constituting each layer according to each network state. According to an embodiment, a model of another algorithm, such as a deep neural network (DNN), a convolutional neural network (CNN), or reinforcement learning (RL), may be applied according to each network state. According to an embodiment, information on these ML models in the application 410 may be configured in the form of priorities of models available according to each network state. In the process of requesting network state information, the application 410 of the UE 420 may transmit minimum data transmission rate and delay level information required for each ML model and algorithm to the network together with the request for network state information. Information transmitted by the application 410 of the UE 420 may be used as a criterion for reporting a congestion level when the network delivers network congestion information to the UE. A control message requesting network state information, which is transmitted by the application 410 of the UE 420, may include information relating to at least one of an AI/ML application identifier, UE location information, a reporting period, a reporting criterion, or accuracy. The reporting criterion included in the network state information request message may include at least one of a congestion level, single-network slice selection assistance information (S-NSSAI), a data network name (DNN), or a prediction level. A request for network state information of the AI/ML application 410 may be transmitted to a modem of the UE through an operating system (OS) or a system application of the UE 420 (indicated by reference numeral 415). A modem of the UE 420 may separately store the request information received from the application 410 or directly use the same to request network state information from the network. In case that the modem of the UE 420 provides an application programming interface (API), it is also possible for the AI/ML application 410 to directly transmit a request for network state information to the modem through the API of the modem.

The modem of the UE 420 may transfer, to a network (e.g., core network (CN)) of the wireless communication system, information on a request for network state information having been received from the AI/ML application 410, through a separate designated control message or using a registration request message in a network registration process (indicated by reference numeral 435). The network state information request message transmitted by the modem of the UE 420 may include at least one of an AI/ML application identifier, UE location information, a reporting period, a reporting criterion, or accuracy.

Upon receiving the network state information request from the UE 420 through a registration request message or a designated control message, the AMF 430 may request subscription information of the UE from the UDM. The AMF 430 may receive subscription information based on a registration request message from the UDM. The AMF 430 may identify, from the received subscription information, whether the AI/ML application 410 of the UE is an application allowed to receive state information or which status information is allowable.

After identifying that the AI/ML application 410 of the UE 420 is allowed to receive the network state information, from the subscription information received from the UDM, the AMF 430 may transmit a message requesting at least one of analysis information or resource state information for each session to the NWDAF 450, SMF, or UPF 440 in order to collect information required for determining the network state information requested by the UE 420 (indicated by reference numerals 445, 455). The AMF 430 may receive at least one of analysis information or resource state information for each session based on a request message from the NWDAF 450, SMF, or UPF 440. The AMF 430 may determine the congestion level of the network from the received information (indicated by reference numeral 465). The AMF 430 may transmit network congestion prediction information to the UE through a control message in case that conditions requested by the UE 420 based on the determined congestion level of the network are satisfied (e.g., the resource usage level exceeds 70% or the total number of UEs using a corresponding slice is predicted to exceed a predetermined criterion within a designated time, etc.) (indicated by reference numeral 475). The network congestion prediction information included in the control message received by the UE 420 may be transferred from the UE modem to the AI/ML application 410 (indicated by reference numeral 425). Based on the received control message, the AI/ML application 410 may identify network congestion prediction information. The AI/ML application 410 may determine an AI/ML model and algorithm to use for learning and inference based on the identified network congestion prediction information. According to an embodiment, when the congestion level is predicted to be low, the application 410 may select a model having high accuracy and high computing requirements as a model to be used for learning and inference (indicated by reference numeral 405). According to an embodiment, when a congestion level is predicted to be high, the application may select a model having low accuracy and low computing requirements as a model to be used for learning and inference, or may delay performing learning and inference operations. According to an embodiment, the AI/ML application 410 may request the AI/ML AF 460 to modify the AI/ML model to be applied and change the size of training data (indicated by reference numeral 485).

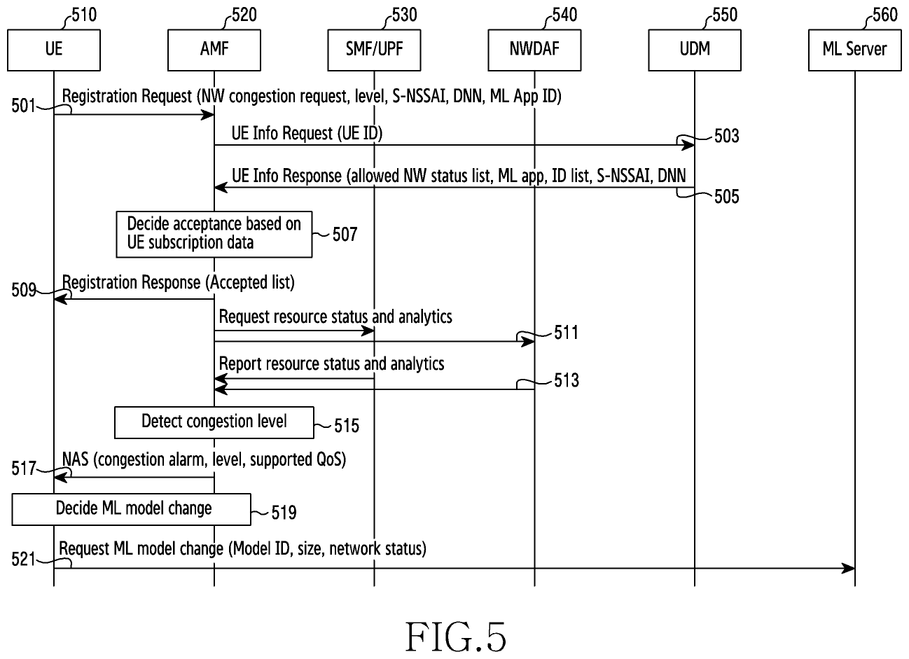

FIG. 5 is a signal flow illustrating collecting and analyzing network data by a UE according to an embodiment of the disclosure. Specifically, FIG. 5 is a signal flow diagram illustrating an operation of collecting and analyzing network data in order to analyze network congestion information requested by an AI/ML application of a UE.

Referring to operation 501, in case that the AI/ML application of the UE 510 requests network state information, the UE may transfer, to a network, information indicating that network state information needs to be transferred during a process of network registration of the UE. According to an embodiment, the UE 510 may transmit a registration request message requesting network state information to an AMF 520. A UE registration request message transmitted by the UE 510 may include at least one of an identifier of an application having requested network state information, information indicating a request for network state information, criteria for reporting state information, a network slice for which state reporting is required, or DNN information.

Referring to operations 503 and 505, the AMF 520 may receive the UE registration request message from the UE. Upon receiving the registration request, the AMF 520 may request subscription information of the UE from the UDM 550 based on the registration request message. The AMF 520 may receive a response message including subscription information of the UE based on the request for UE subscription information, received from the UDM 550. Referring to operation 505, the response message received by the AMF 520 from the UDM 550 is part of subscription information of the UE or separate information, and may include at least one of a list of network state information which is allowed to be provided to the UE by a mobile communication service provider, a list of application identifiers by which use of network state information is allowed, information about network slices, and DNN information.

Referring to operation 507, the AMF 520 may determine whether the network state information requested by the UE is acceptable/allowable based on the response message including the subscription information of the UE and received from the UDM 550.

Referring to operation 509, the AMF 520 may transmit a registration response message to the UE. The registration response message transmitted by the AMF 520 may include a list of applications by which network information is allowed to be provided, together with whether or not the network state information requested by the UE is allowed, or a list of allowed state information.

Referring to operation 511, the AMF 520 may transmit, to the SMF, UPF 530, and NWDAF 540, a message requesting at least one of network performance analysis information or resource state information for each slice, DNN, and NF related to the network state information requested by the UE.

Referring to operation 513, the AMF 520 may receive at least one of the resource state information or network performance analysis information from the SMF, UPF 530, and NWDAF 540, based on the request message transmitted in operation 511.

Referring to operation 515, the AMF 520 may identify at least one of the current congestion level of the network or the congestion level in a prediction period designated by the UE, based on information received from the SMF, UPF 530, and NWDAF 540. According to an embodiment, the AMF 520 may predict the congestion level of the network based on the received information.

Referring to operation 517, the AMF 520 may transmit, to the UE 510, a warning indicator or control message notifying that congestion may occur when the analyzed or identified network congestion level corresponds to the congestion level designated by the UE or has changed. According to an embodiment, the AMF 520 may transmit a warning indicator or control message notifying that congestion may occur to the UE at each reporting period designated by the UE. The warning indicator or control message transmitted by the AMF 520 to the UE may include at least one of congestion level information identified by the AMF 520 and supportable QoS level information.

Referring to operation 519, the UE 510 may transmit the received network congestion prediction information to the AI/ML application. The AI/ML application may determine an AI/ML model and algorithm to be applied to learning and inference based on network congestion prediction information received from the UE. According to an embodiment, when the congestion level is identified or predicted to increase, the AI/ML application may determine to use a simpler and low computationally demanding model for faster operation. According to an embodiment, if the congestion level is identified or predicted to decrease, the AI/ML application may determine to use a more complex and high computationally demanding model for improved accuracy.

Referring to operation 521, the AI/ML application of the UE may transmit at least one of information of an AI/ML model to be applied or network state information to an AI/ML server 560. The AI/ML model information transmitted by the AI/ML application of the UE may include at least one of a model identifier, a size of a model to be applied, or model parameters. The network state information transmitted by the AI/ML application of the UE may include network congestion prediction information.

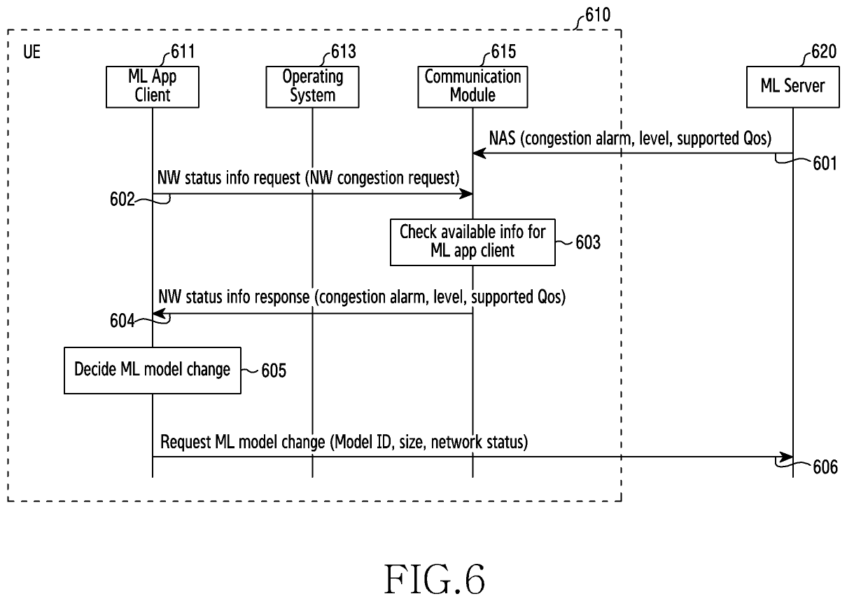

FIG. 6 is a signal flow illustrating changing a model and an algorithm to be applied based on network congestion information received by a UE according to an embodiment of the disclosure.

Referring to FIG. 6, in operation 601, a communication module 615 of a UE 610 may receive network congestion prediction information from a network. According to an embodiment, an operation in which the communication module 615 of the UE 610 receives network congestion prediction information may be performed through the process described in FIG. 5.

In operation 602, the AI/ML application 611 of the UE may request network state information from the communication module 615 of the UE in order to determine a suitable AI/ML model or algorithm. The AI/ML application 611 may transmit a network state information request message including information about the network congestion request to the communication module 615.

In operation 603, the communication module 615 of the UE may identify whether network state information allowed for the AI/ML application 611 of the UE is stored. If necessary, the communication module 615 of the UE may perform an operation for receiving network congestion prediction information from the network by performing the process described in FIG. 5.

In operation 604, the communication module 615 of the UE may transfer the network congestion prediction information received from the network to the AI/ML application 611. The communication module 615 of the UE may transmit a network state information response message including information on at least one of congestion notification, level, or supported QoS to the AI/ML application 611.

In operation 605, the AI/ML application 611 of the UE may determine an AI/ML model or algorithm to be used for learning and inference based on the network congestion prediction information received from the communication module 615 of the UE. According to an embodiment, when a high probability of network congestion is predicted, the AI/ML application 611 may determine to use a simple learning and inference model having a small model size (e.g., a model having a small number of layers or each layer being designed to use a small number of parameters) for learning and inference. According to an embodiment, the AI/ML application 611 may determine to use a learning and inference model having a large model size and applying a complex algorithm when it is predicted that there will be no network congestion.

In operation 606, the AI/ML application 611 of the UE may request the AI/ML server 620 to make necessary changes to use the learning and inference model determined in operation 605. The AI/ML application 611 of the UE may transmit an ML model change request message including information on at least one of an identifier (ID), size, or network state of the model based on the learning and inference model determined in operation 604 to the AI/ML server 620.

According to an embodiment, units (the AI/ML application 611, an operating system 613, or the communication module 615) included in the UE may be implemented as a controller of the UE. The controller implemented by each unit may be included in one logical unit, but is not limited thereto and may be distributed and implemented in each logical unit.

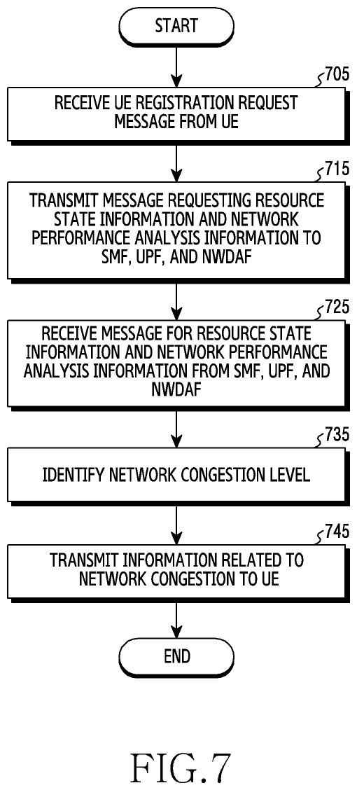

FIG. 7 is a flowchart illustrating an operation of an AMF for determining a machine learning model based on network congestion information according to an embodiment of the disclosure.

Referring to FIG. 7, in operation 705, the AMF may receive a UE registration request message from the UE. According to an embodiment, the UE registration request message received by the AMF may include at least one of an identifier of an application requesting network state information, information indicating a request for network state information, a criterion for reporting state information, a network slice for which state reporting is required, or DNN information. Although not shown in FIG. 7, the AMF having received the registration request may request subscription information of the UE from the UDM based on the registration request message. The AMF may receive a response message including subscription information of the UE based on the request for UE subscription information received from the UDM. The response message received by the AMF from the UDM corresponds to part of subscription information of the UE or separate information, and may include at least one of a list of network state information which is allowed to be provided to the UE by a mobile communication service provider, a list of application identifiers by which use of network state information is allowed, information about network slices, and DNN information. The AMF may determine whether the network state information requested by the UE is acceptable/allowable based on the response message including the subscription information of the UE and received from the UDM. The AMF may transmit a registration response message to the UE. The registration response message transmitted by the AMF may include a list of applications by which network information is allowed to be provided, together with whether or not the network state information requested by the UE is allowed, or a list of allowed state information.

In operation 715, the AMF may transmit, to the SMF, UPF, and NWDAF, a message requesting at least one of network performance analysis information or resource state information for each slice, DNN, and NF related to the network state information requested by the UE.

In operation 725, the AMF may receive at least one of the resource state information or network performance analysis information from the SMF, UPF, and NWDAF, based on the transmitted request message.

In operation 735, the AMF may identify at least one of the current congestion level of the network or the congestion level in a prediction period designated by the UE, based on information received from the SMF, UPF, and NWDAF. According to an embodiment, the AMF may predict the congestion level of the network based on the received information.

In operation 745, the AMF may transmit, to the UE, a warning indicator or control message notifying that congestion may occur when the analyzed or identified (or predicted) network congestion level corresponds to the congestion level designated by the UE or has changed. According to an embodiment, the AMF may transmit a warning indicator or control message notifying that congestion may occur to the UE at each reporting period designated by the UE. The warning indicator or control message transmitted by the AMF to the UE may include at least one of congestion level information identified by the AMF and supportable QoS level information.

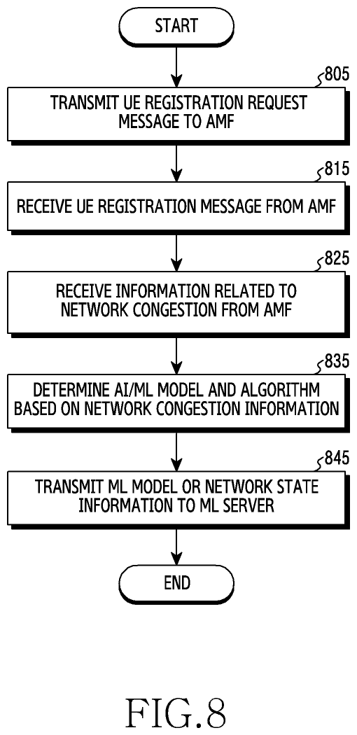

FIG. 8 is a flowchart illustrating an operation of a UE for determining a machine learning model based on network congestion information according to an embodiment of the disclosure.

Referring to FIG. 8, in operation 805, a UE may transmit a UE registration request message to an AMF. Specifically, when an AI/ML application of the UE requests network state information, the UE may transmit information indicating that network state information needs to be transmitted to a network during a process of network registration of the UE. According to an embodiment, the UE may transmit a registration request message requesting network state information to an AMF. A UE registration request message transmitted by the UE may include at least one of an identifier of an application having requested network state information, information indicating a request for network state information, criteria for reporting state information, a network slice for which state reporting is required, or DNN information.

Although not shown in FIG. 8, the AMF having received the registration request may request subscription information of the UE from the UDM based on the registration request message. The AMF may receive a response message including subscription information of the UE based on the request for UE subscription information received from the UDM. The response message received by the AMF from the UDM corresponds to part of subscription information of the UE or separate information, and may include at least one of a list of network state information which is allowed to be provided to the UE by a mobile communication service provider, a list of application identifiers by which use of network state information is allowed, information about network slices, and DNN information. The AMF may determine whether the network state information requested by the UE is acceptable/allowable based on the response message including the subscription information of the UE and received from the UDM.

In operation 815, the UE may receive a registration response message from the AMF. The registration response message received by the UE may include a list of applications by which network information is allowed to be provided, together with whether or not the network state information requested by the UE is allowed, or a list of allowed state information.

Although not shown in FIG. 8, the AMF may transmit, to the SMF, UPF, and NWDAF, a message requesting at least one of network performance analysis information or resource state information for each slice, DNN, and NF related to the network state information requested by the UE. The AMF may receive at least one of the resource state information or network performance analysis information from the SMF, UPF, and NWDAF, based on the transmitted request message transmitted in operation 511. The AMF may identify at least one of the current congestion level of the network or the congestion level in a prediction period designated by the UE, based on information received from the SMF, UPF, and NWDAF. According to an embodiment, the AMF may predict the congestion level of the network based on the received information.

In operation 825, the UE may receive, from the AMF, a warning indicator or control message notifying that congestion may occur when the network congestion level analyzed or identified by the AMF corresponds to the congestion level designated by the UE or has changed. According to an embodiment, the AMF may transmit a warning indicator or control message notifying that congestion may occur to the UE at each reporting period designated by the UE. The warning indicator or control message transmitted by the AMF to the UE may include at least one of congestion level information identified by the AMF and supportable QoS level information.

In operation 835, the UE may transmit the received network congestion prediction information to the AI/ML application. The AI/ML application may determine an AI/ML model and algorithm to be applied to learning and inference based on network congestion prediction information received from the UE. According to an embodiment, when the congestion level is identified or predicted to increase, the AI/ML application may determine to use a simpler and low computationally demanding model for faster operation. According to an embodiment, when the congestion level is identified or predicted to decrease, the AI/ML application may determine to use a more complex-and-high computationally demanding model for improved accuracy.

In operation 845, the AI/ML application of the UE may transmit at least one of information of an AI/ML model to be applied or network state information to an AI/ML server. The AI/ML model information transmitted by the AI/ML application of the UE may include at least one of a model identifier, a size of a model to be applied, or model parameters. The network state information transmitted by the AI/ML application of the UE may include network congestion prediction information.

An access and mobility management function (AMF) node device in a wireless communication system according to various embodiments of the disclosure may include a transceiver, and a controller coupled to the transceiver, wherein the controller is configured to receive a first control message including information on a registration request from a terminal, transmit, to the terminal, a registration response message including information on whether network analysis of the terminal is acceptable, transmit a message requesting information on the network analysis based on the first control message to a network data collection and analysis function (NWDAF) node, receive information on the network analysis from the NWDAF node, identify information about network congestion of the terminal based on the information on the network analysis, and transmit a second control message including information about the network congestion to the terminal.

According to an embodiment, the controller may be further configured to receive a message including subscription information of the terminal based on the first control message from a unified data management (UDM) node, and identify whether network analysis of the terminal is acceptable, based on the subscription information.

According to an embodiment, the first control message may include information on at least one of single-network slice selection assistance information (S-NSSAI) of the terminal, a data network name (DNN), or a reporting period.

According to an embodiment, the second control message may be transmitted based on the reporting period included in the first control message.

According to an embodiment, the information about the network congestion may be used to identify an artificial intelligence (AI)/machine learning (ML) model used by the terminal.

A terminal device in a wireless communication system according to various embodiments of the disclosure may include a transceiver, and a controller coupled to the transceiver, wherein the controller is configured to transmit a first control message including information on a registration request to an access and mobility management function (AMF) node, receive, from the AMF node, a registration response message including information on whether network analysis of the terminal is acceptable, receive, from the AMF node, a second control message including information about network congestion, which is identified based on information about network analysis transmitted from a network data collection and analysis function (NWDAF) node, and identify an artificial intelligence (AI)/machine learning (ML) model used by the terminal based on the information about the network congestion.

According to an embodiment, the registration response message may be received based on subscription information of the terminal, transmitted from a unified data management (UDM) node.

According to an embodiment, the first control message may include information on at least one of single-network slice selection assistance information (S-NSSAI) of the terminal, a data network name (DNN), or a reporting period.

According to an embodiment, the second control message may be received based on the reporting period included in the first control message.

According to an embodiment, the controller may be further configured to transmit information about the identified AI/ML model to an ML server.

A method performed by an access and mobility management function (AMF) node in a wireless communication system according to various embodiments of the disclosure may include receiving a first control message including information on a registration request from a terminal, transmitting, to the terminal, a registration response message including information on whether network analysis of the terminal is acceptable, transmitting a message requesting information on the network analysis based on the first control message to a network data collection and analysis function (NWDAF) node, receiving information on the network analysis from the NWDAF node, identifying information about network congestion of the terminal based on the information on the network analysis, and transmitting a second control message including information about the network congestion to the terminal.

According to an embodiment, the method may further include receiving a message including subscription information of the terminal based on the first control message from a unified data management (UDM) node, and identifying whether network analysis of the terminal is acceptable, based on the subscription information.

According to an embodiment, the first control message may include information on at least one of single-network slice selection assistance information (S-NSSAI) of the terminal, a data network name (DNN), or a reporting period.

According to an embodiment, the second control message may be transmitted based on a reporting period included in the first control message.

According to an embodiment, the information about the network congestion may be used to identify an artificial intelligence (AI)/machine learning (ML) model used by the terminal.

A method performed by a terminal in a wireless communication system according to various embodiments of the disclosure may include transmitting a first control message including information on a registration request to an access and mobility management function (AMF) node, receiving, from the AMF node, a registration response message including information on whether network analysis of the terminal is acceptable, receiving, from the AMF node, a second control message including information about network congestion, which is identified based on information about network analysis transmitted from a network data collection and analysis function (NWDAF) node, and identifying an artificial intelligence (AI)/machine learning (ML) model used by the terminal based on the information about the network congestion.

According to an embodiment, the registration response message may be received based on subscription information of the terminal, transmitted from a unified data management (UDM) node.

According to an embodiment, the first control message may include information on at least one of single-network slice selection assistance information (S-NSSAI) of the terminal, a data network name (DNN), or a reporting period.

According to an embodiment, the second control message may be received based on the reporting period included in the first control message.

According to an embodiment, the method may further include transmitting information about the identified AI/ML model to an ML server.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, the respective embodiments of the disclosure may be at least partially combined with each other to operate a base station and a terminal.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An access and mobility management function (AMF) node in a wireless communication system, the AMF node comprising:
a transceiver; and
a controller coupled to the transceiver,
wherein the controller is configured to:
receive, from a user equipment (UE), a first control message including information on a registration request,
transmit, to the UE, a registration response message including information on whether a network analysis of the UE is allowed,
transmit, to a network data collection and analysis function (NWDAF) node, message requesting information on the network analysis based on the first control message,
receive, from the NWDAF node, the information on the network analysis,
identify information on a network congestion of the UE based on the information on the network analysis, and
transmit, to the UE, a second control message including the information on the network congestion.

2. The AMF node of claim 1, wherein the controller is further configured to:
receive, from a unified data management (UDM) node, a message including subscription information of the UE based on the first control message; and
identify whether the network analysis of the UE is allowed based on the subscription information.

3. The AMF node of claim 1, wherein the first control message includes information on at least one of a single-network slice selection assistance information (S-NSSAI), a data network name (DNN), or a reporting period of the UE.

4. The AMF node of claim 3, wherein the second control message is transmitted based on the reporting period included in the first control message.

5. The AMF node of claim 1, wherein the information on the network congestion is used to identify an artificial intelligence (AI)/machine learning (ML) model used by the UE.

6. A user equipment (UE), in a wireless communication system, the UE comprising:
a transceiver; and
a controller coupled to the transceiver,
wherein the controller is configured to:
transmit, to an access and mobility management function (AMF) node, a first control message including information on a registration request,
receive, from the AMF node, a registration response message including information on whether a network analysis of the UE is allowed,
receive, from the AMF node, a second control message including information on a network congestion identified based on information on a network analysis transmitted from a network data collection and analysis function (NWDAF) node, and
identify an artificial intelligence (AI)/machine learning (ML) model used by the UE based on the information on the network congestion.

7. The UE of claim 6, wherein the registration response message is received based on subscription information of the UE transmitted from a unified data management (UDM) node.

8. The UE of claim 6, wherein the first control message includes information on at least one of a single-network slice selection assistance information (S-NSSAI), a data network name (DNN), or a reporting period of the UE.

9. The UE of claim 8, wherein the second control message is received based on the reporting period included in the first control message.

10. The UE of claim 6, wherein the controller is further configured to:
transmit, to a ML server, information on the identified AI/ML model.

11. A method performed by an access and mobility management function (AMF) node in a wireless communication system, the method comprising:
receiving, from a user equipment (UE), a first control message including information on a registration request;
transmitting, to the UE, a registration response message including information on whether a network analysis of the UE is allowed;
transmitting, to a network data collection and analysis function (NWDAF) node, message requesting information on the network analysis based on the first control message;
receiving, from the NWDAF node, the information on the network analysis;
identifying information on a network congestion of the UE based on the information on the network analysis; and
transmitting, to the UE, a second control message including the information on the network congestion.

12. The method of claim 11, further comprising:
receiving, from a unified data management (UDM) node, a message including subscription information of the UE based on the first control message; and
identifying whether the network analysis of the UE is allowed based on the subscription information.

13. The method of claim 11, wherein the first control message includes information on at least one of a single-network slice selection assistance information (S-NSSAI), a data network name (DNN), or a reporting period of the UE.

14. The method of claim 13, wherein the second control message is transmitted based on the reporting period included in the first control message.

15. The method of claim 11, wherein the information on the network congestion is used to identify an artificial intelligence (AI)/machine learning (ML) model used by the UE.

16. A method performed by a user equipment (UE), in a wireless communication system, the method comprising:
transmitting, to an access and mobility management function (AMF) node, a first control message including information on a registration request;
receiving, from the AMF node, a registration response message including information on whether a network analysis of the UE is allowed;
receiving, from the AMF node, a second control message including information on a network congestion identified based on information on a network analysis transmitted from a network data collection and analysis function (NWDAF) node; and
identifying an artificial intelligence (AI)/machine learning (ML) model used by the UE based on the information on the network congestion.

17. The method of claim 16, wherein the registration response message is received based on subscription information of the UE transmitted from a unified data management (UDM) node.

18. The method of claim 16, wherein the first control message includes information on at least one of a single-network slice selection assistance information (S-NSSAI), a data network name (DNN), or a reporting period of the UE.

19. The method of claim 18, wherein the second control message is received based on the reporting period included in the first control message.

20. The method of claim 16, further comprising:
transmitting, to a ML server, information on the identified AI/ML model.
